(19) United States
(12) Patent Application Publication
(10) Pub. No.: US 2003/0234509 A1
(43) Pub. Date: Dec. 25, 2003

(54) Bicycle folding device

(76) Inventors: Ying-Chi Chen, Taipei (TW); Tien-Hua Lin, Taipei (TW); Cheng-Fei Lin, Taipei (TW)

Correspondence Address: Ying-Chi Chen, 235 Chung - Ho, Box 8-24, Taipei, TW

(21) Appl. No.: 10/174,812

(22) Filed: Jun. 20, 2002

(51) Int. Cl. B62M 15/00

(52) U.S. Cl. 280/278

(57) ABSTRACT

A bicycle folding device comprising a first folding portion and a second folding portion. The first folding portion has a groove, a first axial hole, an axial arranged guide hole, a buckling groove. The second folding portion has an inner axial hole. The pivotal unit serves to pivot the first folding portion and the second folding portion. The quick-detaching unit serves to position the second folding portion. A lever set is placed at a middle section between the second inner end and the second outer end. The lever set has a lever, a handle at a front end of the lever; and a key which is supported by an elastomer and is at a distal end of the lever set. By above structure, the bicycle frame can be assembled and detached easily and firmly. No noise occurs as the bicycle frame is transferred.

### FIELD OF THE INVENTION

The present invention relates to bicycle frames, and particularly to a bicycle folding device of the bicycle frame which is positioned safely.

### BACKGROUND OF THE INVENTION

Referring to FIGS. 1 and 2, a prior art bicycle folding device comprises a first folding portion 1 connected to a front end 501 of a bicycle frame 5; a second folding portion 2 connected to a rear end 502 of the frame; a pivotal rod 3 and a quick-detaching unit 4.

A groove 101 is formed at an inner surface of the first folding portion 1 for receiving the second folding portion 2. A first axial hole 102 is positioned at the first inner end. A concave hole 103 is formed at a middle section of the outer end.

The second folding portion has a first inner end and a second outer end. The second folding portion has an inner axial hole 201 at a position with respect to the axial hole 102 of the first folding portion 1. The pivotal rod 3 serves to pivot an outer axial tube 202 at the outer end with respect to the concave hole 103 of the first folding portion 20. The quick-detaching unit 4 is placed in the outer axial tube 202. The quick-detaching unit 4 has a threaded rod 402 with a spring 401 installed round the rod. The lower end of the threaded rod is connected to an interior actuating piece 403 in the outer axial tube 202. A top end of the threaded rod 402 has a positioning block 404 and a handle 405.

Thereby, as shown in FIGS. 1 and 2, when the second folding portion 2 is pivotally rotated to couple the first folding portion 1, a part of the threaded rod 402 of the quick-detaching unit 4 enclosing by the spring 401 is limited in the concave hole 103. Then the handle 405 is moved. The lower end of the handle 405 has a cam structure. The positioning block 404 will be pressed and the handle 405 resists against the outer wall 104 of the first folding portion 1. As a result, the first folding portion 1 is coupled to the second folding portion 2 and the front end 501 and rear end 502 of the bicycle frame 5 are assembled for being used.

As shown in FIGS. 2 and 3, when it is desired to store the bicycle frame 5, the handle 405 is moved so that the positioning block 404 releases from the outer wall 104 of the first folding portion 1, namely, the first folding portion 1 and second folding portion 2 are decoupled so that the bicycle frame 5 is detached. Thereby, the front end 501 and rear end 502 are arranged in parallel.

In the prior art bicycle frame, the first folding portion 1 and second folding portion 2 are arranged at a middle section of the bicycle frame 5, so that the bicycle frame can be folded as desired (referring to FIG. 3). Thereby, when the first folding portion 1 and second folding portion 2 are expanded, there is no positioning structure. When the bicycle frame 5 is transferred or the bicycle frame-S is carried, the front end 501 of the bicycle frame 5 is not fixed to the rear end 502 thereof. Thus, the bicycle frame 5 will shake and make noise. Not only the whole structure is not firmly secured, but also the front end 501 and rear end 502 are not arranged in order.

### SUMMARY OF THE INVENTION

Accordingly, the primary object of the present invention is to provide to a bicycle folding device of the bicycle frame which is positioned safely by dual effects.

To achieve above objects, the present invention provides a bicycle folding device comprising a first folding portion connected to a front end of a bicycle frame; a second folding portion connected to a rear end of the frame. The first folding portion and second folding portion are connected by a pivotal unit and a quick-detaching unit.

The first folding portion has a first inner end and a first outer end. A groove at an inner surface of the first folding portion serves for receiving the second folding portion. A first axial hole is positioned at the first inner end. An axial arranged guide hole is at the first outer end. A buckling groove is positioned at one top lateral wall of the first inner end.

The second folding portion has a second inner end and a second outer end. The second folding portion has an inner axial hole at a position with respect to the first axial hole of the first folding portion. The pivotal unit serves to pivot the first folding portion with the second folding portion. An outer axial hole at an outer end of the second folding portion is arranged with respect to the guide hole of the first folding portion. The quick-detaching unit serves to position the second outer end.

A lever set is placed at a middle section between the second inner end and the second outer end. The lever set has a lever, a handle at a front end of the lever; and a key which is supported by an elastomer and is at a distal end of the lever set. When the second folding portion is pivotally rotated to be coupled with the first folding portion, the key is placed in a receiving groove of the second folding portion.

The various objects and advantages of the present invention will be more readily understood from the following detailed description when read in conjunction with the appended drawing.

### BRIEF DESCRIPTION OF THE DRAWINGS

FIG. 1 is an assembled view of a prior art bicycle folding device.

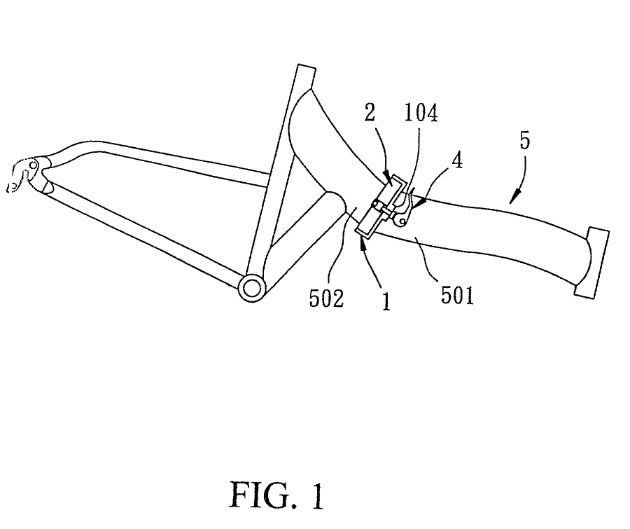

FIG. 2 is an expanding view of the prior art bicycle folding device.

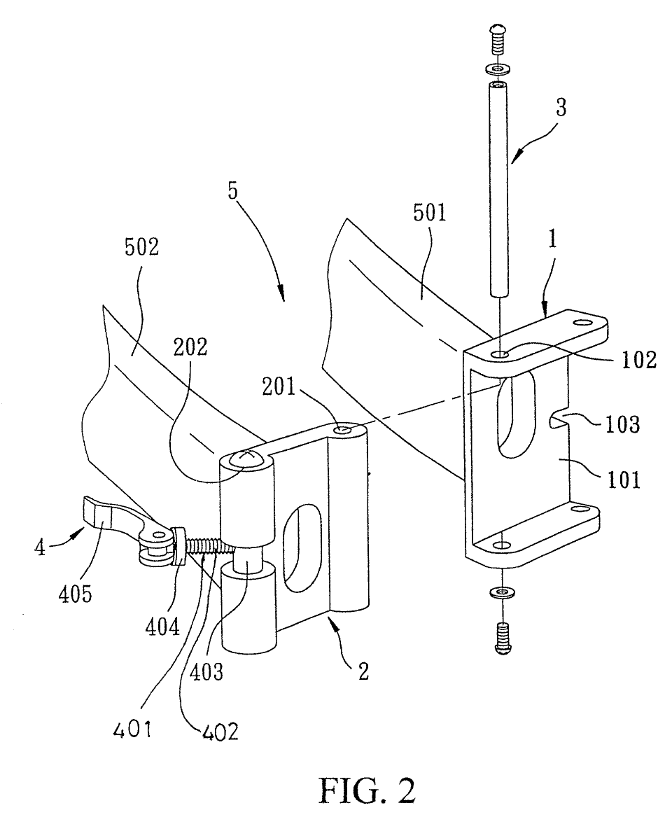

FIG. 3 is a perspective view showing the folding status of the prior art bicycle folding device.

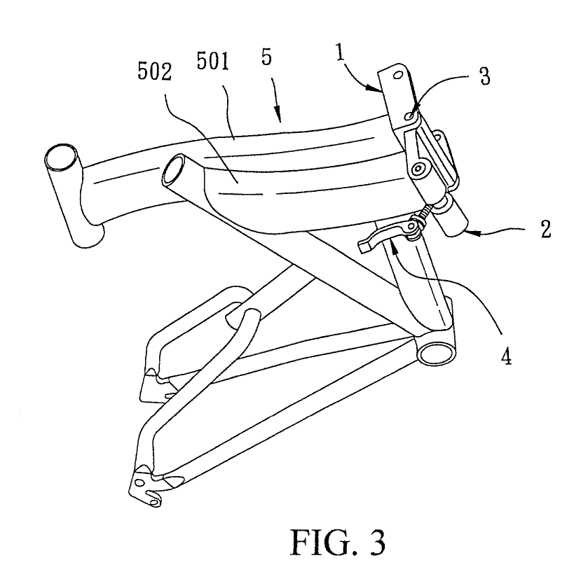

FIG. 4 is an assembled perspective view showing one preferred embodiment of the bicycle folding device of the present invention.

FIG. 5 is an exploded perspective view of the preferred embodiment of the present invention.

FIG. 6 is an expanding plane view of the bicycle folding device of the present invention, wherein a lever set is actuated so that a key extends axially.

FIG. 7 is a top view of FIG. 6 showing positioning of a bicycle folding device of the present invention.

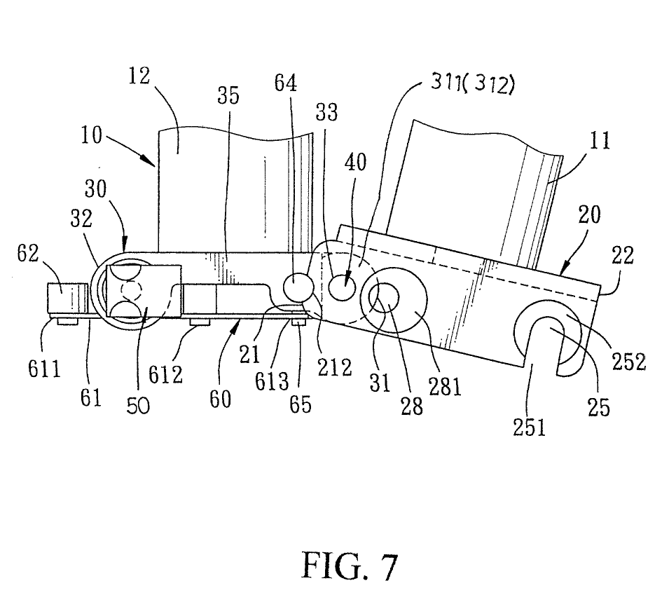

FIG. 8 is an assembled cross sectional view of the bicycle folding device of the present invention.

FIG. 9 is a top view of the bicycle frame of FIG. 8.

### DETAILED DESCRIPTION OF THE PREFERRED EMBODIMENTS

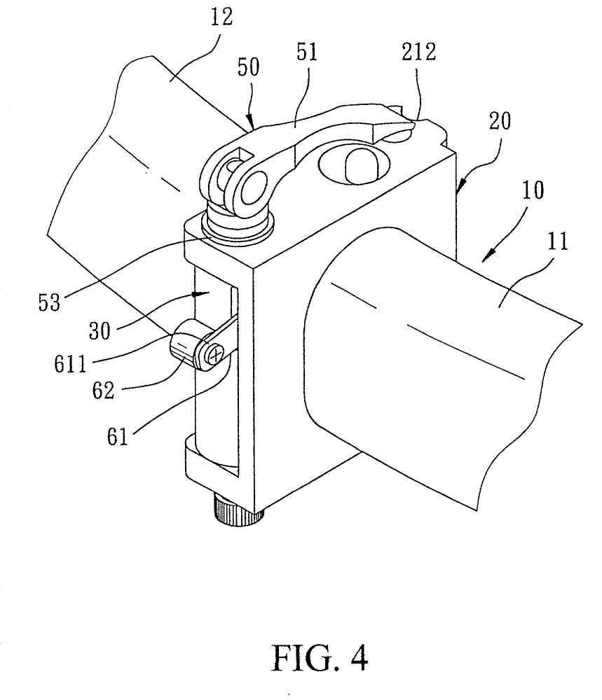

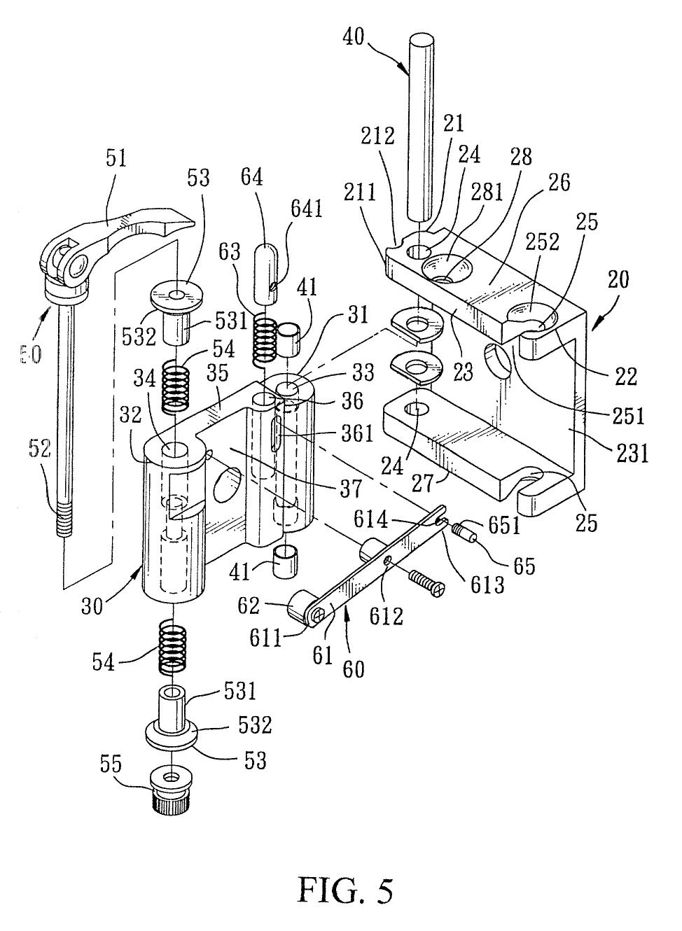

Referring to FIGS. 4 and 5, a preferred embodiment of the bicycle folding device of the present invention is illustrated. The bicycle folding device comprises a first folding portion 20 connected to a front end 11 of a bicycle frame 10; a second folding portion 30 connected to a rear end 12 of the frame 10. The first folding portion 20 and second folding portion 30 are connected by a pivotal unit 40 and a quick-detaching unit 50.

Referring to FIG. 5, the first folding portion 20 has an inner end 21 and an outer end 22; a groove 231 at an inner surface 23 of the first folding portion 20 for receiving the second folding portion 30; an axial hole 24 positioned at the inner end 21; an axial arranged guide hole 25 at the outer end 22 (the guide hole 25 has an opening 251 of the guide hole 25 facing the inner surface 23); and a-buckling groove 212 at one top lateral wall 211 of the inner end 21. The guide hole 25 has a top surface 26 and a bottom surface 27 each of which is formed with a tapered surface 252. Besides, one side of the guide hole 25 near the axial hole 24 is formed with a positioning hole 28 which is horizontally arranged with respect to the buckling groove 212. The positioning hole 28 has a tapered surface 281 facing the top surface 26. With reference to FIG. 5, the second folding portion 30 has an inner end 31 and an outer end 32. The two ends of the inner end 31 are reduced for being placed with a washer 311 (312). The second folding portion 30 has an inner axial hole 33 at a position with respect to the axial holes 24 of the first folding portion 20. The pivotal unit 40 serves to pivot the first folding portion 20 and the second folding portion 30. Two sleeves 41 and two washers 311 and 312 serves to fix the first folding portion 20 and second folding portion 30. An outer axial hole 34 at the outer end 32 of the second folding portion 30 is corresponding to the guide hole 25 of the first folding portion 20. The quick-detaching unit 50 serves to position the outer end 32. A receiving groove 36 near the inner end 31 and is opened at a top surface 35. A lever set 60 is placed at a middle section 37 between the inner end 31 and the outer end 32.

The lever set 60 has a lever 61, a handle 62 at a front end of the lever 61; a spring 63 and a key 64 which are sequentially arranged in the receiving groove 36 of the second folding portion 30. A middle section of the key 64 has a threaded hole 641. When the key 64 is placed in the receiving groove 36, the receiving groove 36 has a long hole 361 which is communicated with outer side. A pin 65 with a threaded distal end 651 passes through the long hole 361 and then inserts into the threaded hole 641 so that the pin 65 is perpendicularly combined to the key 64. The elastic force of the spring 63 resists the pin 65 so that the key 64 presses the spring 63 to hid into the receiving groove 36. Then the second folding portion 30 can be separated from the groove 231 of the first folding portion 20. When the handle 62 is released, the spring 63 returns to drive the key 64 to protrude from the top surface 35 of the second folding portion 30. Since the first folding portion 20 and second folding portion 30 have been expanded, the key 64 exactly resists against the buckling groove 212. The front end 11 and rear end 12 of the bicycle frame 10 are parallelly arranged and folded. Since the buckling groove 212 and the key 64 are buckled to one another, the front end 11 and rear end 12 of the bicycle frame 10 are positioned firmly without loosing in transfer.

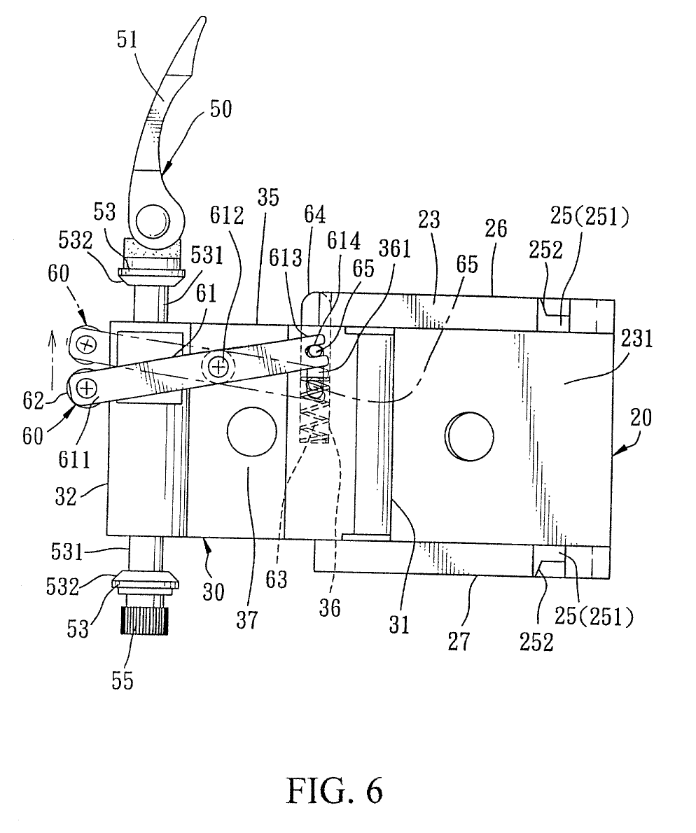

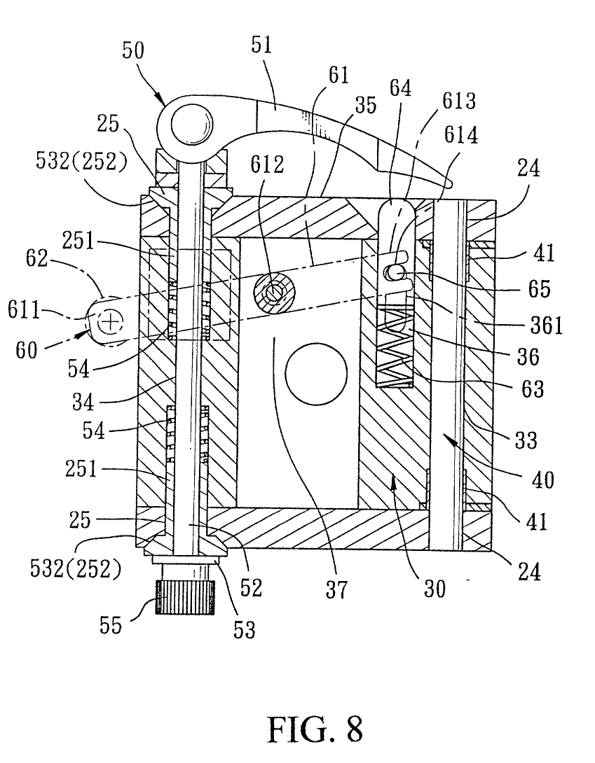

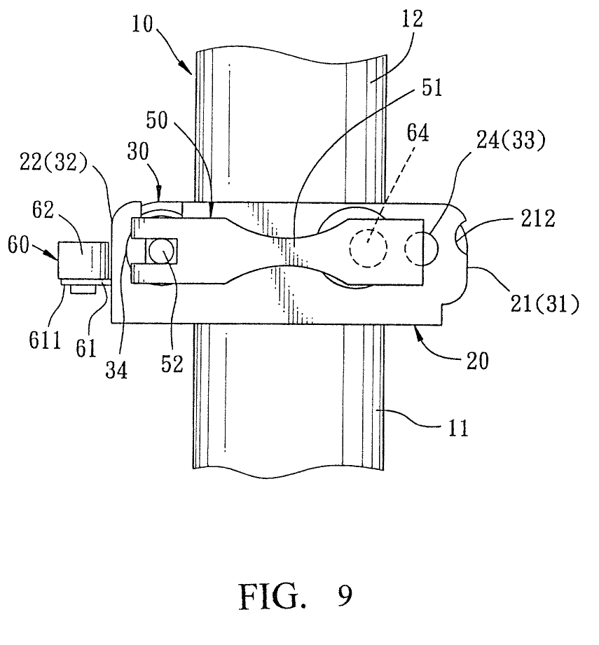

With reference to FIG. 6, when the bicycle frame 10 to be assembled again, the handle 62 must be pulled upwards. The distal end 613 of the lever 61 will drive the key 64 by the pin 65. Thereby, the key 64 will press the spring 63 to hid in the receiving groove 36. Then, the second folding portion 30 is coupled to the groove 231 of the first folding portion 20. When the handle 62 is released, as illustrated in FIGS. 8 and 9, the spring 63 returns so that the key 64 will protrude from the positioning hole 28 of the first folding portion 20. Then the first folding portion 20 and second folding portion 30 are assembled with the bicycle frame 10. By the key 64 to be inserted into the positioning hole 28, the bicycle frame 10 is positioned. Then, the handle 51 is pressed further so that the tapered portions 532 of the two positioning blocks 53 of the quick-detaching unit 50 are matched to the tapered surface 252 of the first folding portion 20 again. As a result, the bicycle frame 10 is positioned again. In summary, the bicycle folding device of the present invention ahs the following advantages.

Since when the first folding portion 20 and second folding portion 30 are expanded, by the buckling groove 21-2 of the first folding portion 20 is buckled to the key 64 of the second folding portion 30, the front end 11 and the rear end 12 of the folded bicycle frame 10 can be positioned firmly and no noise occurs in transfer.

In the present invention, after the first folding portion 20 and second folding portion 30 are expanded, by the key 64 to be positioned in the positioning hole 28, the positioning operation can be achieved. Moreover, by pressing and positioning the quick-detaching unit 50, the positioning effect is further enhanced. Moreover, the bicycle folding device of the present invention has an enhanced positioning effect.

If the quick-detaching unit 50 is used for a long time, since the positioning effect of the present invention is enhanced, so that even the parts are released or loosed, the bicycle frame 10 may be firmly secured to be retained in a safety condition.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle folding device comprises a first folding portion connected to a front end of a bicycle frame; a second folding portion connected to a rear end of the frame; the first folding portion and second folding portion being connected by a pivotal unit and a quick-detaching unit; wherein
the first folding portion has a first inner end and a first outer end; a groove at an inner surface of the first folding portion for receiving the second folding portion, a first axial hole positioned at the first inner end, an axially arranged guide hole at the first outer end; and a buckling groove at one top lateral wall of the first inner end;
the second folding portion has a first inner end and a second outer end; the second folding portion has an inner axial hole at a position with respect to the first axial hole of the first folding portion; the pivotal unit serves to pivot the first folding portion with respect to the second folding portion; an outer axial hole at an outer end of the second folding portion is arranged with respect to the guide hole of the first folding portion; the quick-detaching unit serves to position the second outer end; and
a lever set is placed at a middle section between the second inner end and the second outer end; the lever set has a lever, a handle at a front end of the lever, and a key which is supported by an elastomer and is at a distal end of the lever; when the second folding portion is pivotally rotated to couple the first folding portion, the key is placed in a receiving groove of the second folding portion.

2. The bicycle folding device as claimed in claim 1, wherein the guide hole of the first folding portion has a top tapered surface and a bottom tapered surface, larger openings of the top tapered surface and bottom tapered surface faces outwards.

3. The bicycle folding device as claimed in claim 1, wherein the quick-detaching unit has a handle, a threaded rod, two positioning blocks, two springs, and a nut; an inner end of each positioning block is formed with a tapered portion which has a tilting orientation opposite to the top surface of the guide hole of the first folding portion so that the positioning blocks and the guide hole are connected to one another.

4. The bicycle folding device as claimed in claim 1, wherein one side of the guide hole near the first axial hole is formed with a positioning hole which is horizontally arranged with respect to the buckling groove.
